(19) United States
(12) Patent Application Publication
(10) Pub. No.: US 2025/0289670 A1
(43) Pub. Date: Sep. 18, 2025

(54) INTERNAL PRODUCT RELEASE APPARATUS FOR FLAT WIRE CONVEYOR BELT SYSTEMS

(71) Applicant: Messer Industries USA, Inc., Bridgewater, NJ (US)

(72) Inventors: Weston Miller, Boyertown, PA (US); Eugene Mello, JR., Columbia, SC (US)

(73) Assignee: Messer Industries USA, Inc., Bridgewater, NJ (US)

(21) Appl. No.: 19/075,864

(22) Filed: Mar. 11, 2025

Related U.S. Application Data
(60) Provisional application No. 63/564,532, filed on Mar. 13, 2024.

(51) Int. Cl. B65G 39/073; B65G 15/30; B65G 45/10

(52) U.S. Cl. CPC B65G 39/073; B65G 45/10; B65G 15/30; B65G 2201/0202

(57) ABSTRACT

An apparatus is provided for removing product from a conveying belt having a plurality of openings therein. The apparatus includes a movable member with a surface area and a plurality of protruding members constructed and arranged to extend from the surface area for movement into and out of corresponding ones of the plurality of openings from a first side of the conveying belt, the plurality of protruding members adapted to contact and dislodge the product through to a second side of the conveying belt opposite to the first side for subsequent removal of the product from the conveying belt.

### BACKGROUND OF THE INVENTION

The present embodiments relate to apparatus for removing products, such as for example food products, from conveyor belts.

Known conveyors and conveying belt systems may include a belt with a uniform, continuous surface, a mesh belt woven from a myriad of strands wherein there is provided a myriad of holes or voids in the mesh belt, or a flat wire belt wherein there is provided a myriad of holes or voids in the flat wire belt. Each type of belt manufacture can be formed from metal or plastics and can be of various sizes and lengths.

Mesh and flat wire conveyor belts, regardless of material used to produce same, have inherent challenges regarding cleaning of these types of belts and dislodging product from the belt, when such product may have become captured in one or more of the holes in the belt. For these types of belts, and the continuous belt as well, scraper devices have been used to remove by scraping the product from the belt.

Known scraper devices assist with the removal and release of a product from the belt. These belt system scrapers include the scraper disposed external to an upper or outer surface of the belt for co-action therewith at an end shaft or axle for the belt just after same begins its return from turning around the shaft or axle for the belt. The known scrapers are rigid longitudinal members, e.g., planks, manufactured from for example stainless steel or ultra-high molecular weight (UHMW) plastic, such as for example UHMW polyethylene. Such scrapers have an area or region constructed and arranged to be wedged between the product and a surface of the belt, regardless of belt type, in order to pry and dislodge the product from the belt. The dislodged product usually is permitted to fall away from the belt under gravity, whereupon the unused product is collected in a container or conveyed by another conveying device to a remote location for further processing.

Unfortunately, when the known belts are used, the known scrapers are able to scrape only that portion of the product present at an exterior facing or outer surface of the belt, thereby leaving product trapped in the openings in the mesh or flat wire belt. The known manner of scraping will also result in the product becoming stuck against and clogging or fouling the scraper. If the product is a food product, the known ineffective scraper removal can result in contamination of the food product remaining at the belt and the scraper.

### SUMMARY OF THE INVENTION

An apparatus for removing product from a conveying belt having a plurality of openings therein is provided which includes a movable member with a surface area and a plurality of protruding members constructed and arranged to extend from the surface area for movement into and out of corresponding ones of the plurality of openings from a first side of the conveying belt, the plurality of protruding members adapted to contact and dislodge the product through to a second side of the conveying belt opposite to the first side for subsequent removal of the product from the conveying belt.

### BRIEF DESCRIPTION OF THE DRAWINGS

For a more complete understanding of the present invention, reference may be had to the following description of exemplary embodiments considered in connection with the accompanying drawing Figures, of which:

FIG. 1 shows a top perspective view of a flat wire conveyor belt system having an embodiment of the internal product release apparatus of the present invention.

FIG. 2 shows another top perspective view of the internal product release apparatus of FIG. 1.

FIG. 3 shows a top plan view of the internal product release apparatus of FIGS. 1 and 2.

FIG. 4 shows a side plan partial view taken along line 4-4 in FIG. 3.

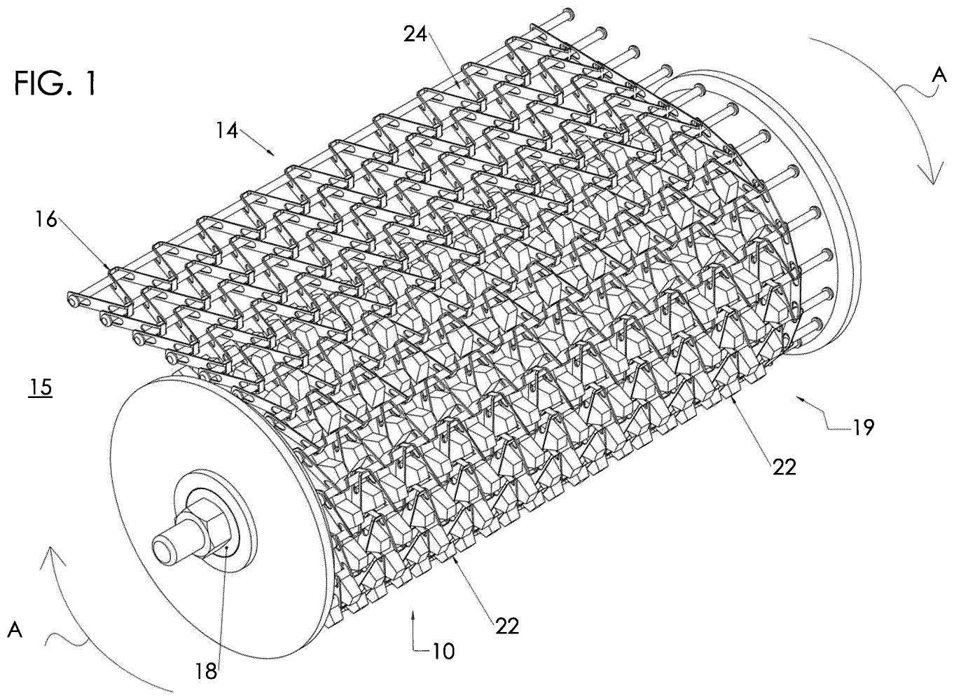

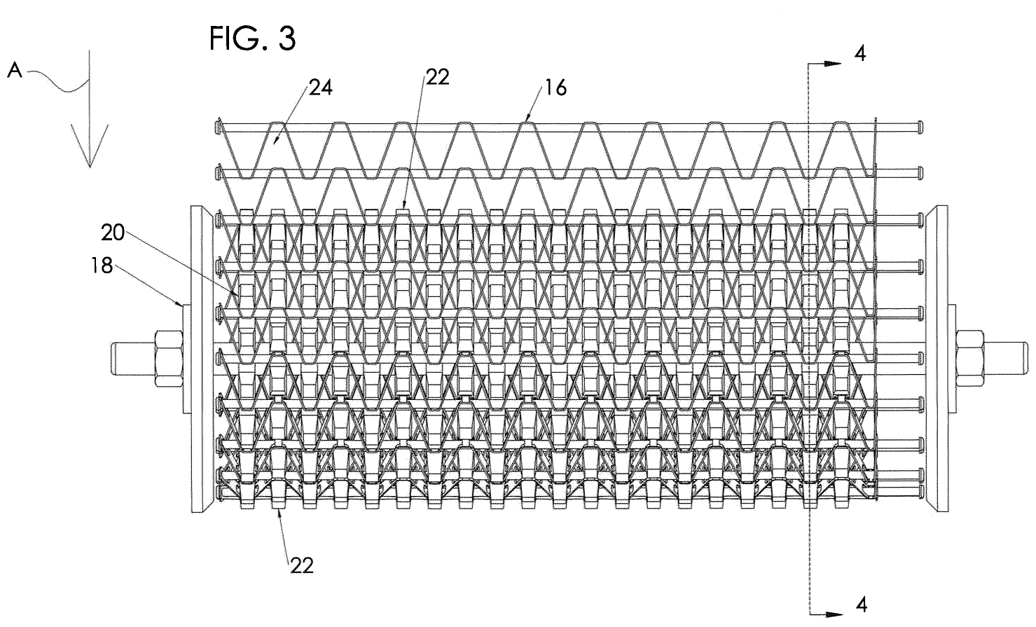

The embodiments shown in FIGS. 1-4 and described below are not to scale.

### DETAILED DESCRIPTION OF THE INVENTION

Before explaining the inventive embodiments in detail, it is to be understood that the invention is not limited in its application to the details of construction and arrangement of parts illustrated in the accompanying drawings, since the invention is capable of other embodiments and being practiced or carried out in various ways. Also, it is understood that the phraseology or terminology employed herein is for the purpose of description and not of limitation.

In the following description, terms such as a horizontal, upright, vertical, above, below, beneath and the like, are to be used solely for the purpose of clarity illustrating the invention and should not be taken as words of limitation. The drawings are for the purpose of illustrating the invention and are not intended to be to scale.

Referring to FIGS. 1-4, an internal product release apparatus (or, an internal scraper) of the present inventive embodiments is shown generally at 10. The apparatus 10 is constructed and arranged to lift, dislodge, and remove product 12, such as food product by way of example only, from a conveyor belt system 14. Other of the product 12 that may be transported by the belt system 14 can include wet or sticky products other than food items. The conveyor belt system 14 includes a belt 16 driven or moved by a powered shaft or axle (not shown) about which the belt is actuated. The powered shaft is driven by a motor (not shown). The belt 16 may be a flat wire belt, a mesh belt or any other type of belt having a myriad of holes or apertures formed in the belt.

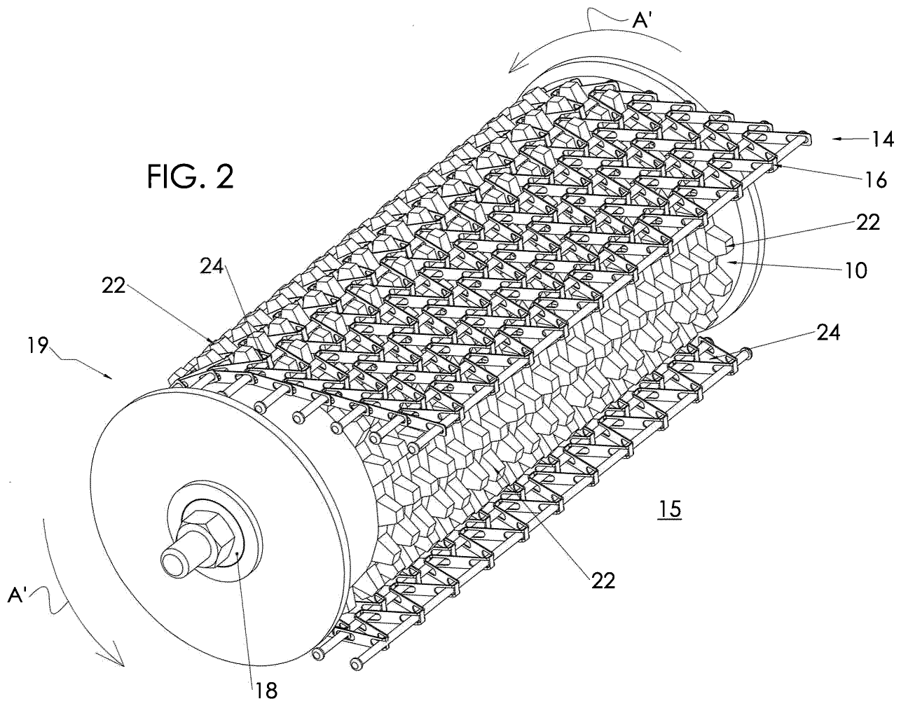

The embodiments in FIGS. 1 and 2 are the same, only the perspective view is different for each of the Figures. That is, the view of FIG. 1 shows the apparatus 10 and the conveyor belt system 14 moving in a clockwise direction as represented by arrows A, while the view of FIG. 2 shows the apparatus 10 and conveyor belt system 14 moving in a counterclockwise direction as represented by arrows A′.

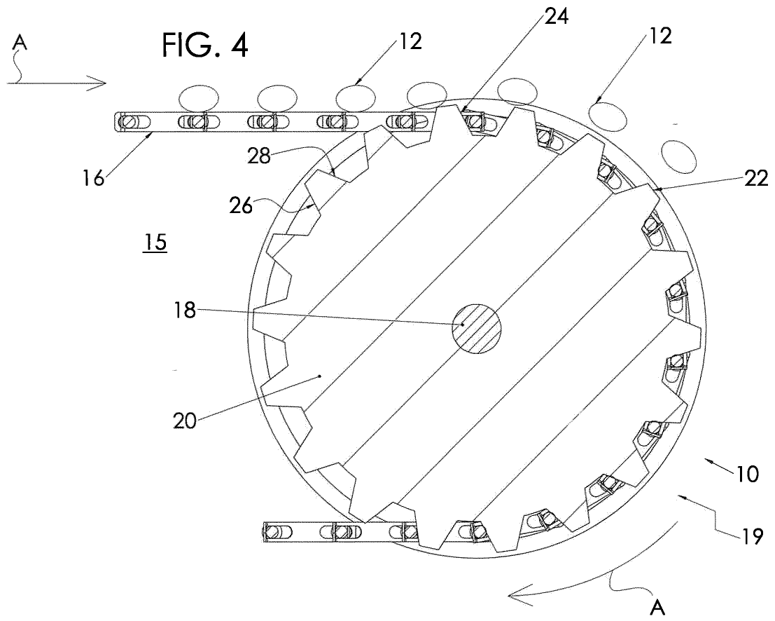

The belt 16 may be fabricated from a plurality of interlocking metallic wire pieces or members, or a plurality of interlocking plastic strands, depending upon the environment in which the conveyor belt is located, and the type of product being conveyed on the belt. The apparatus 10 is disposed for operation in a space 15 or region (see for example FIG. 4) defined by the belt 16, and such arrangement allows the product 12 to more easily and efficiently be released, dislodged and removed from the belt with far less, if any at all, product remaining on the belt.

A roller 18 is mounted at a discharge end 19 or region of the conveyor belt system 14. The belt 16 is driven over the roller 18 by the powered shaft so that the belt will engage the apparatus 10 of the present embodiments. The roller 18 may be fixed in position. In another embodiment, the roller 18 may be rotatable about its longitudinal axis. The roller 18 extends or spans a length substantially equal to a width of the belt 16.

In FIGS. 1 and 4 the belt 16 is being moved in a clockwise direction. In FIG. 2 the belt 16 shown from a different perspective is being moved in a counterclockwise direction.

Referring more particularly to FIGS. 1 and 4, a plurality of collars 20 are each mounted to an exterior surface of the roller 18, each one of the collars being separately rotatable about the roller. Another embodiment of the apparatus 10 calls for each one of the collars 20 being friction fit to the roller 18 such that each collar may by positioned differently about the collar when compared to other ones of the collars. Still another embodiment of the apparatus 10 calls for the collars 20 being formed as an integral unit or as a unitary sleeve through which the roller 18 is inserted. For each of the embodiments described above, a plurality of fingers 22 or teeth or other type of protruding members extend from a surface of each one of the collars 20. The collars 20 and the fingers 22 may be formed from the same material, i.e., metal or plastic. And, the plastic may be very flexible for a purpose to be described below. For certain applications, the collar 20 and/or the fingers 22 may be formed from a material similar to that which is used to form the belt 16.

Still referring to FIGS. 1 and 4, in one embodiment the roller 18 is stationary or fixed in place, such that the collars 20 rotate around the roller in a clockwise direction driven by overpassing belt 16 as shown. That is, the belt 16 is driven be another shaft (a powered shaft, not shown) which moves the belt toward the discharge end of the conveyor belt system 14 such that the belt moving over the fingers 22 forces the collars to rotate, thereby moving the fingers to be positioned to co-act with the belt. As shown in FIG. 4, the apparatus 10 with the roller 18 and the collars 20 are positioned at the discharge end of the belt 16, after which the belt begins its return run.

In effect, the apparatus 10 rotates around its roller 18. Although FIG. 4 shows the fingers 22 extending from only a portion of the surface of the collar 20, it is understood that each of the collars can be formed with a surface from which the fingers 22 extend all the way around the surface.

As the belt 16 is moved with the product 12 on the belt, the apparatus 10 rotates as well such that each of the fingers 22 extending from each of the collars 20 comes into registration with and is inserted into a corresponding one of the holes 24 in the belt to contact any product in the corresponding hole, dislodge the product from the hole so that the dislodged product is removed from the belt when same commences its turn as shown in FIG. 4.

An alternative embodiment of the apparatus 10 has the fingers 22 fabricated from a flexible material, such as a rubber compound. Each one of the flexible fingers 22 therefore functions as a dislodging member and a squeegee to remove and dislodge the product from the corresponding hole 24, and to scrape or brush an inner perimeter or side of each hole in the belt 16 for increased cleaning of the belt. Use of the flexible fingers 22 permits same to bend and to more consistently and reliably engage a corresponding one of the holes 24 when or if the belt is undulating slightly with a wavelike motion during operation.

Each one of the teeth 22 of the apparatus 10 are formed with a frustoconical shape with pitch taper as shown for example in FIG. 4. At least two opposed surfaces 26,28 of each one of the teeth 22 are provided with the pitch taper to facilitate introducing each of the teeth into a corresponding one of the holes 24 in the belt 16. The construction of each of the teeth as shown and the interaction of the teeth with the belt also facilitates release of the teeth from the belt when same reverses direction along its path of travel as shown in FIG. 4. This frustoconical, tapered construction of each of the teeth 22 ensures that the belt is disengaged from the teeth when the belt makes a turn to resume a different path of travel so that the belt does not stack up upon itself during the turn. Alternatively, each one of the plurality of teeth 22 have a frustoconical sidewall tapering from a base portion with a first diameter at the corresponding collar 22 extending upward to a top portion having a second diameter being less than the first diameter. The sidewall may also consist of a first planar surface with a first surface area at the sidewall, and a second planar surface with a second surface area at an opposed side of the sidewall as shown in FIG. 4.

The apparatus 10 can be used alone or in conjunction with the known belt scrapers (not shown) to remove the product 12 from the belt 16.

The apparatus 10 avoids damage to the product 12 which can occur when the product is trapped between a conveyor belt and the known belt scrapers.

The apparatus 10 can be used with any type of flat wire belt system, or open mesh belt system, where product adhering or sticking to the belt is a concern, operationally and/or hygienically, and can be used in freezing or chilling systems, and cooking and heating systems for products 12, such as food products.

Another embodiment of the apparatus includes, wherein the movable member is mounted to a roller, and the movable member is adapted to rotate about the roller for co-action with the conveying belt.

Another embodiment of the apparatus includes, wherein the movable member is disposed at a discharge end of the conveying belt.

Another embodiment of the apparatus includes, wherein the plurality of protruding members are each constructed from a material selected from the group consisting of metal, plastic and other polymers, high density foam, and rubber.

Another embodiment of the apparatus includes, wherein the plurality of protruding members are each sized and shaped to be in registration with a corresponding one of the plurality of openings to dislodge product from the corresponding ones of the openings and scrap the product from an inner surface area of each one of the plurality of the openings.

Another embodiment of the apparatus includes each one of the plurality of protruding members having a tooth pitch taper at opposed sides of each of the teeth.

Another embodiment of the apparatus includes, wherein the movable member has a length substantially equivalent to a width of the conveying belt.

Another embodiment of the apparatus includes, wherein the movable member comprises a collar.

Another embodiment of the apparatus includes, wherein the movable member comprises a plurality of collars.

Another embodiment of the apparatus includes, wherein the conveying belt comprises a flat wire belt.

Another embodiment of the apparatus includes, wherein the plurality of protruding members are each constructed in a shape selected from the group consisting of teeth, and fingers.

Another embodiment of the apparatus includes, wherein the product is a substance selected from the group consisting of food products, wet products, and sticky products.

Another embodiment of the apparatus includes, wherein the movable member is adapted for actuation by the conveying belt for the movable member to co-act with the plurality of openings.

It will be understood that the embodiments described herein are merely exemplary, and that a person skilled in the art may make variations and modifications without departing from the spirit and scope of the invention. All such variations and modifications are intended to be included within the scope of the invention as provided in the appended claims. It should be understood that the embodiments described above are not only in the alternative, but can be combined.

What is claimed is:

1. An apparatus for removing product from a conveying belt having a plurality of openings therein, comprising:
a movable member with a surface area and a plurality of protruding members constructed and arranged to extend from the surface area for movement into and out of corresponding ones of the plurality of openings from a first side of the conveying belt, the plurality of protruding members adapted to contact and dislodge the product through to a second side of the conveying belt opposite to the first side for subsequent removal of the product from the conveying belt.

2. The apparatus of claim 1, wherein the movable member is mounted to a roller, and the movable member is adapted to rotate about the roller for co-action with the conveying belt.

3. The apparatus of claim 1, wherein the movable member is disposed at a discharge end of the conveying belt.

4. The apparatus of claim 1, wherein the plurality of protruding members are each constructed from a material selected from the group consisting of metal, plastic and other polymers, high density foam, and rubber.

5. The apparatus of claim 1, wherein the plurality of protruding members are each sized and shaped to be in registration with a corresponding one of the plurality of openings to dislodge product from the corresponding ones of the openings and scrape the product from an inner surface area of each one of the plurality of the openings.

6. The apparatus of claim 1, wherein the movable member has a length substantially equivalent to a width of the conveying belt.

7. The apparatus of claim 1, wherein the movable member comprises a collar.

8. The apparatus of claim 1, wherein the movable member comprises a plurality of collars.

9. The apparatus of claim 1, wherein each protruding member of the plurality of protruding members comprises a sidewall extending from the surface area at a first diameter to a second diameter less than the first diameter.

10. The apparatus of claim 9, wherein the sidewall comprises a first planar surface with a first surface area at the sidewall, and a second planar surface with a second surface area at an opposed side of the sidewall.

11. The apparatus of claim 1, wherein the conveying belt comprises a flat wire belt.

12. The apparatus of claim 1, wherein the plurality of protruding members are each constructed in a shape selected from the group consisting of teeth, and fingers.

13. The apparatus of claim 1, wherein the product is a substance selected from the group consisting of food products, wet products, and sticky products.

14. The apparatus of claim 1, wherein the movable member is adapted for actuation by the conveying belt for the plurality of protruding members to co-act with the plurality of openings.
